(19) United States
(12) Patent Application Publication
(10) Pub. No.: US 2024/0178989 A1
(43) Pub. Date: May 30, 2024

(54) POLYNOMIAL REPRESENTATION OF NN FOR COMMUNICATION-LESS SMPC AND METHOD OF PERFORMING STATISTICAL INFORMATION-THEORETICAL SECURE (SITS) DISTRIBUTED COMMUNICATION-LESS SMPC (DCLSMPC) OF A DISTRIBUTED UNKNOWN FINITE STATE MACHINE (DUFSM)

(71) Applicant: B.G. NEGEV TECHNOLOGIES AND APPLICATIONS LTD., AT BEN-GURION UNIVERSITY, Beer Sheva (IL)

(72) Inventors: Shlomi DOLEV, Omer (IL); Stav DOOLMAN, Shoham (IL); Philip DERBEKO, Modi'in (IL)

(21) Appl. No.: 18/280,088

(22) PCT Filed: Mar. 3, 2022
(86) PCT No.: PCT/IL2022/050241

§ 371 Date: Sep. 1, 2023

Related U.S. Application Data
(60) Provisional application No. 63/155,751, filed on Mar. 3, 2021.
(60) Provisional application No. 63/155,754, filed on Mar. 3, 2021.
(60) Provisional application No. 63/174,052, filed on Apr. 13, 2021.

(51) Int. Cl. H04L 9/00; G06N 3/02

(52) U.S. Cl. CPC H04L 9/008; G06N 3/02

(57) ABSTRACT

A system for performing effective secure multi-party computation by participating parties being one or more computerized devices for executing the multi-party computation, with no communication between the parties, using at least one trained Deep Neural Network (DNN), comprising one or more computerized devices that contain one or more processors being adapted to approximate the at least one trained DNN by polynomial functions representing a single or multiple layers of the DNN by representing each neuron unit of the DNN by a polynomial being a weighted sum of vector multiplication of weights with an n-dimensional input; representing the output of each neuron unit by applying an activation function to the weighted sum; generate additive secret shares for every polynomial coefficient; distribute the secret shares among the participating parties; send the input x to the participating parties, for execution; after execution, receive the output of polynomial activation function of each participating party; output the final result as the sum of the received output.

### FIELD OF THE INVENTION

The present invention relates to the field of cyber security. More particularly, the invention relates to a system and method for performing Secure Multi-Party Computation (SMPC), with no communication between the parties, using Deep Neural Networks (DNNs) and to distributed computing, with applications in Blockchain systems, including private executable service contracts and NFTs and DNN Coins.

### BACKGROUND OF THE INVENTION

Deep Neural Networks (DNN) are the state-of-the-art form of Machine Learning (ML) techniques. DNNs are used for speech recognition, image recognition, computer vision, natural language processing, machine translation, and many other applications. Similar to other Machine Learning (ML) methods, DNN is based on finding patterns in the data and, hence, the method embeds information about the data into a concise and generalized model. Subsequently, the sharing of the DNN model also reveals private and valuable information about the data.

The structure and weights of Deep Neural Networks (DNNs) typically encode and contain very valuable information about the dataset that was used to train the Neural Network (nn). One way to protect this information when a DNN is published is to perform an interference of the network using Secure Multi-Party Computations (SMPC).

There are situations where the data owner collects the data, trains the model, and shares the model to be used by clients. The model is very valuable for the data owner, since the training process is resource-intensive and frequently performed over private and valuable data. Therefore, the data owner wishes to retain control of the model as much as possible after it was shared. The data owner will likely be willing to delegate the query service to (Machine Learning Data model Store MLDSore [7]) clouds, in a way that the cloud providers do for computing platforms. In case, the cloud providers should not be able to simply copy the model and reuse it. In addition, the data owner should have the ability to limit the number of queries executed on the model, such that a single, or a small team of colluding cloud providers (or servers) cannot execute an unlimited number of queries on the data model.

A DNN can be represented by a (nested) polynomial, therefore enough queries (points on the polynomial) can reveal the neural network, and the ownership of the information (succinct model) is at risk. In practice, as data is constantly updated, new data emerges and old data becomes obsolete. Therefore, frequent updates of the neural network are sufficient to define a new polynomial, for which the past queries are not relevant.

A previous study [6] shows an algorithm to distributively share DNN-based models while retaining control and ownership over the shared model. The activation functions of neural network units were approximated with polynomials and an efficient, additive secret sharing based, MPC protocol for information-secure calculations of polynomials was shown.

Calculating the neural network activation with secure multi-party computations algorithms requires the translation of activation functions from floating-point arithmetic to fixed-point. The regular activation functions of neural network units use floating-point arithmetic for the accuracy of the calculations, as the penalty of such calculations on modern CPUs is small. However, distributed MPC protocols are built for fixed-point arithmetic, and many times even for limited range values.

Approximation of neural network units' activation function with fixed-point arithmetic was described in [9, 10], where polynomial functions were suggested for approximation. In both references, the network was not distributed but rather was translated into fixed-point calculations to run over encrypted data. However, the methods of approximation are similar to the MPC case.

CryptoDL [10] showed an implementation of Convolutional Neural Networks (CNN) over encrypted data using homomorphic encryption (HE). Since fully homomorphic encryption is limited to addition and multiplication operations, CryptoDL [10] has shown approximation of CNN activation functions by low-degree polynomials due to the high-performance overhead of higher degree polynomials.

The calculation of neural networks with secure multi-party computations was described in [12]. Sigmoid and softmax activation functions were replaced with functions that can be calculated with MPC. However, the polynomial approximation of the sigmoid function requires at least a 10-degree polynomial, which causes a slow performance with garbled circuit protocol. Therefore, they propose to replace sigmoid and softmax activation functions with a combination of ReLu activation functions, multiplication, and addition. However, this last reference had a limitation for two participating parties and the algorithm was shown to be limiting in terms of performance and the practical size of the network.

CrypTFlow [11] describes a system that automatically converts TensorFlow (TF) code into secure multi-party computation protocol. The system comprises a compiler, from TF code into two and three-party secure computations, an optimized three-party computation protocol for secure interference, and a hardware-based solution for computation integrity. The most salient characteristic of CrypTFlow is the ability to automatically translate the code into MPC protocol, where the specific protocol can be easily changed and added. The optimized three-party computational protocol is specifically targeted for NN computation and speeds up the computation. This approach is similar to the holistic approach of [1].

SecureNN [15] proposed arguably the first practical three-party secure computations, both for training and for activation of DNN and CNN. The improvement over the state-of-the-art results is achieved by replacing garbled circuits and oblivious transfer protocols with secret sharing protocols, which allowed information security rather than of computational security. This reference provides a hierarchy of protocols allowing the calculation of activation functions of neural networks. However, these protocols are specialized for three-party computations and their adaptation for more computational parties is complex. Also, theproposed protocols require ten communication rounds for ReLu calculation of a single unit, excluding counting share distribution rounds.

Another approach to speed up performance is deccribed in [5], which concentrated on two-party protocols and showed a mixed protocol framework based on Arithmetic sharing, Boolean sharing, and Yao's garbled circuit (ABY). Each protocol was used for its specific ability, and the protocols are mixed to provide a complete framework for neural networks activation functions.

It is therefore an object of the present invention to provide a system and method for performing secure multi-party computation, with no communication between the parties, using Deep Neural Networks (DNNs).

It is another object of the present invention to provide a system and method for performing secure multi-party computation, which supports any number of participating servers.

It is a further object of the present invention to provide a system and method for performing secure multi-party computation, which optimizes communication-less MPC calculations of a shared DNN.

It is still another object of the present invention to provide a system and method for performing secure multi-party computation, which is capable of nesting a multi-layer polynomial, to reduce the redundant calculations of the intermediate layers.

Other objects and advantages of the invention will become apparent as the description proceeds.

### SUMMARY OF THE INVENTION

A method for performing effective secure multi-party computation by participating parties being one or more computerized devices for executing the tasks, with no communication between the parties, using at least one trained Deep Neural Network (DNN), comprising:
a) approximating the at least one trained DNN by polynomial functions representing a single or multiple layers of the DNN by:
   a.1) representing each neuron unit of the DNN by a polynomial being a weighted sum of vector multiplication of weights with an n-dimensional input;
   a.2) representing the output of each neuron unit by applying an activation function to the weighted sum;
b) generating additive secret shares for every polynomial coefficient;
c) distributing the secret shares among the participating parties;
d) sending the input x to the participating parties, for execution;
e) after execution, receiving the output of polynomial activation function of each participating party; and
f) outputting the final result as the sum of the received output.

The trained DNN may be approximated by a single polynomial or by a single nested polynomial.

The polynomial approximation of each layer may be nested within the approximation of the next layer, such that a single polynomial approximates several layers of the DNN, or the entire DNN.

In one aspect, perfect information theoretically secure, secret-sharing MPC calculation of the polynomial representing the DNN may be preformed.

The activation functions may be selected form the group of:

$$\\ ReLu ( ReLu ( x ) = max ( 0 , x ) ) ,$$

$$\\ Leaky ReLu ( similar to ReLu but LReLu ( x ) = 0.01 x if x \leq 0 )$$

$$\\ Sigmoid ( σ ( x ) = \frac{1}{1 + {e}^{- x}} )$$

$$\\ TANh ( tanh ( x ) = \frac{{e}^{{}^{} 2 x} - 1}{{e}^{{}^{} 2 x} + 1} )$$

$$\\ SoftMax ( σ ( {x}_{i} ) = \frac{{e}^{{}^{} {x}_{i}}}{{\sum }_{i = 1}^{k} {e}^{{}^{} {x}_{i}}} )$$

The polynomial represents multiplications and additions may be performed by a convolution layer of the DNN.

Calculation of the polynomial may be performed using the Add.split procedure implementing a secret sharing scheme.

Approximation multiple layers of the DNN may be performed by combining multiple layers into a single polynomial activation function, according to the connectivity of the layers.

Non-dense layers may be approximated using corresponding inputs from the previous layer.

The degree of the polynomial may be decreased by nesting.

The polynomial degree at layer l may be limited by:

a) keeping the polynomials from layer l−1 as a sum of lower-degree polynomials; b) calculating the polynomial Pᵢⱼ only once, during the calculating of each multi-layer polynomial.

The network architecture may be concealed by:
a) adding pseudo-nodes to the DNN;
b) connecting the pseudo-node similarly to units of the dense layer, with input from all units of the previous layer and output connected to all units of the next layer;
c) nullifying the influence of the pseudo-units on the network inference by canceling the results of activating the pseudo units or nullifying an output edge weights.

The input may be revealed to all participating parties and the secrets are the weights of the trained DNN.

The input may be distributed by secret sharing.

The polynomial may be blindly computed, where some of its coefficients being secret shares of zero, thereby allowing blind execution of the DNN.

The machine learning may be delegated of to a third party without revealing information about the collected data, the inputs/queries, and the outputs by using FHE and a nested polynomial.

A method for performing Statistical Information-Theoretical Secure (SITS) Distributed Communication-Less Secure Multiparty Computation (DCLSMPC) of a Distributed Unknown Finite State Machine (DUFSM), comprising:
a) passing secret shares of the input(s) and output(s) to/from the computing parties, with no communication between the computing parties throughout the computation;
b) providing a polynomial representation or a Look-Up Table (LUT) representation of the transition table of the DUFSM, for arithmetic circuits evaluation, joined with a CRT secret sharing scheme and FHE, to computationally mitigate information leakage from individual CRT shares;
c) implementing the DUFSM by secret sharing of the the transition table or the coefficients of the polynomial over a finite ring, to imply communication-less SMPC of the DUFSM, the polynomial encoding the information of all the transitions from a state x and input y to the next state z;
d) describing the polynomial by an arithmetic circuit that can be evaluated distributively by the SMPC participants, while allowing each participant to evaluate the arithmetic circuit using CRT-SITS secret sharing scheme where the shares are encrypted using FHE.

The computed transition function may be kept private by using secret shares for all coefficients of the polynomial, while revealing only a bound on the maximal degree k of the polynomial.

Independent additions and multiplications of the respective components of two (or more) numbers over a finite ring may be enabled using CRT representation, where each participant performs calculations over a finite ring defined by its corresponding prime number.

The transition function of the state machine may be represented by a bi-variate polynomial from the current state (x) and the input (y) to the next state (z).

The transition function of the state machine may be represented by a univariate polynomial defined by using the most significant digits of (x+y) to encode the state (x) and the least significant digits, to encode the input (y).

More parties may be added to the computation, whenever the result of a calculation does overflow the ring bounds

Larger primes may be chosen for computation, whenever the result of a calculation does overflow the ring bounds.

A distributed calculation may be carried out using a dealer-worker scheme, where a single party being a dealer is responsible for the assignment of tasks and collection of the results, while other parties being workers are responsible to the calculation itself. The dealer may be allowed to generate the appropriate primes and distributes them to the workers where throughout the computation, the dealer manages a queue that is shared with the workers in such a manner that every time an input arrives, the input is pushed to the queue and popped in turn by the workers and then the dealer is allowed to recover the result.

Computations may be executed with respect to a unique modulus, to prevent overflow, or exceeding the finite ring.

The workers may perform a blind modulo reduction to the result, keeping it inside the field.

The dealer may initialize an FHE for encrypting both the initial value and the incoming input, decrypt the encrypted results and reassemble the results by the CRT into a single solution.

A method for managing a trained data model of a neural network, comprising allowing a blockchain registered data owner to sell the rights on the data model services and/or at least a part of the ownership to other parties by representing the owned data as an executable cryptocoin.

The cryptocoin may be selected to provide beneficial reaction to requests including the examples from the group of:
DNNCoin;
SRCoin;
PACoin;
JCCoin;
stock recommendation executable;
psychological advisor executable;
entertaining jumping cat executable.

A system for performing effective secure multi-party computation by participating parties being one or more computerized devices for executing the multi-party computation, with no communication between the parties, using at least one trained Deep Neural Network

(DNN), comprising one or more computerized devices that contain one or more processors being adapted to:
a) approximate the at least one trained DNN by polynomial functions representing a single or multiple layers of the DNN by:
   a.1) representing each neuron unit of the DNN by a polynomial being a weighted sum of vector multiplication of weights with an n-dimensional input;
   a.2) representing the output of each neuron unit by applying an activation function to the weighted sum;
b) generate additive secret shares for every polynomial coefficient;
c) distribute the secret shares among the participating parties;
d) send the input x to the participating parties, for execution;
e) after execution, receive the output of polynomial activation function of each participating party; and
f) output the final result as the sum of the received output.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically illustrates a representation of a single neuron unit;

FIG. 2 schematically illustrates a of max function of Equation 2;

FIG. 3 shows a simple example of a high-level architecture of the auto-encoder neural network, that can be approximated by a single polynomial function;

FIG. 4 shows an example network with an input layer on the left, two dense hidden layers U1 and U2, and an output layer on the right, consisting of a single unit;

FIG. 5 shows an example of a network with pseudo-units of a simple network of FIG. 4 with two added pseudo-units;

FIG. 6 shows the difference in accuracy of the network with different degrees;

FIG. 7 shows a simple nano State Machine; and

FIG. 8 shows an Encoded NANO State Machine.

### DETAILED DESCRIPTION OF THE INVENTION

The present invention relates to a system and method for performing effective secure multi-party computation, with no communication between the parties, using Deep Neural Networks (DNNs), which can be approximated with polynomial functions representing a single, or multiple layers.

In a first embidiment, a trained neural network has been approximated with a single (possibly nested) polynomial, to speed up the calculation of the polynomial on a single node. Accordingly, the polynomial approximation of each layer was nested within the approximation of the next layer, such that a single polynomial (or arithmetic circuit) will approximate not only a single network unit, but several layers, or even the entire network. This embodiment provides an efficient, perfect information theoretically secure, secret-sharing MPC calculation of the polynomial calculation of DNN.

The present invention provides a translation of deep neural networks into polynomials (which are easier to calculate efficiently with MPC techniques), including a way to translate complete networks into a single polynomial and how to calculate the polynomial with an efficient and information-secure MPC algorithm. The calculation is done without intermediate communication between the participating parties, which is beneficial. The participating parties may be one or more computerized devices (such as remote computers, remote servers or hardware devices that contain one or more processors).

### 3 Neural Network as Polynomial Functions in Case of a Single Node

The goal is to approximate the activation functions that are a typical part of DNNs, by polynomials, while focusing on the most commonly used functions in neural networks.

### Weighted Sum of the Unit Input

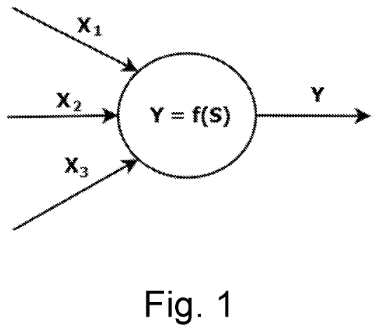

FIG. 1 schematically illustrates a representation of a single neuron unit. The neuron receives inputs X₁, . . . , Xₙ and calculates a weighted sum of the inputs S=Σᵢ₌₁ⁿwᵢXᵢ−b, where b is a bias of the neuron. The output of the neuron unit is the result of the activation function f( ) on S.

The weighted sum is a multiplication of inputs X₁, . . . , Xₙ by the corresponding weights S=Σᵢ₌₁ⁿwᵢXᵢ−b.

The sum is approximated with a polynomial, as it is a vector multiplication of weight with the n-dimensional input, i.e., a polynomial of degree 1.

### Common Activation Functions

Approximating DNN activation functions are focused on several common functions:

$$\\ ReLu ( ReLu ( x ) = max ( 0 , x ) ) ,$$

$$\\ Leaky ReLu ( similar to ReLu but LReLu ( x ) = 0.01 x if x \leq 0 )$$

$$\\ Sigmoid ( σ ( x ) = \frac{1}{1 + {e}^{- x}} )$$

$$\\ TANh ( tanh ( x ) = \frac{{e}^{{}^{} 2 x} - 1}{{e}^{{}^{} 2 x} + 1} )$$

$$\\ SoftMax ( used for multi ‐ class prediction σ ( {x}_{i} ) = \frac{{e}^{{}^{} {x}_{i}}}{{\sum }_{i = 1}^{k} {e}^{{}^{} {x}_{i}}} )$$

These functions can be approximated with a polynomial using various different methods, for example as described in [16, 10, 12, 1, 13]. The optimization method proposed by the present invention is agnostic to a specific approximation method.

The communication-less approach proposed by the present invention allows to use a higher degree polynomials, where a single (nested) polynomial is used for many or even all units (30-degree Chebyshev polynomials achieve good results).

### Convolution Layer

A convolution layer is used in Convolutional Neural Networks (CNN), mainly for image recognition and classification. Usually, this layer performs dot product of a (commonly) n×n square of data points (pixels), in order to calculate the local features. The convolution layer performs multiplication and addition, which are directly translated into a polynomial.

### Max and Mean Pooling

Max and Mean pooling compute the corresponding functions of a set of units. Those functions are frequently used in CNN following the convolution layers. Reference [16] suggested replacing max-pooling with a scaled mean-pooling, which is trivially represented by a polynomial. However, this requires the replacement to be done during the training stage.

For networks that did not replace max pooling with mean and as an alternative, max function can be approximated by:

$$\\ \begin{matrix}max ( {x}_{1} , … , {x}_{n} ) = {lim}_{d \to ∞} {( {\sum }_{i} {x}_{i}^{{}^{} d} )}^{\frac{1}{d}} & ( 1 )\end{matrix}$$

When d=1 the approximation is reduced to a scaled mean pooling function, i.e., without division by the number of elements.

A simple and practical variation of the equation (1) is:

$$\\ \begin{matrix}{m}^{{}^{} ′} ( x , y ) = \frac{x + y}{2} + {( {( x - y )}^{2} )}^{1 / 2} . & ( 2 )\end{matrix}$$

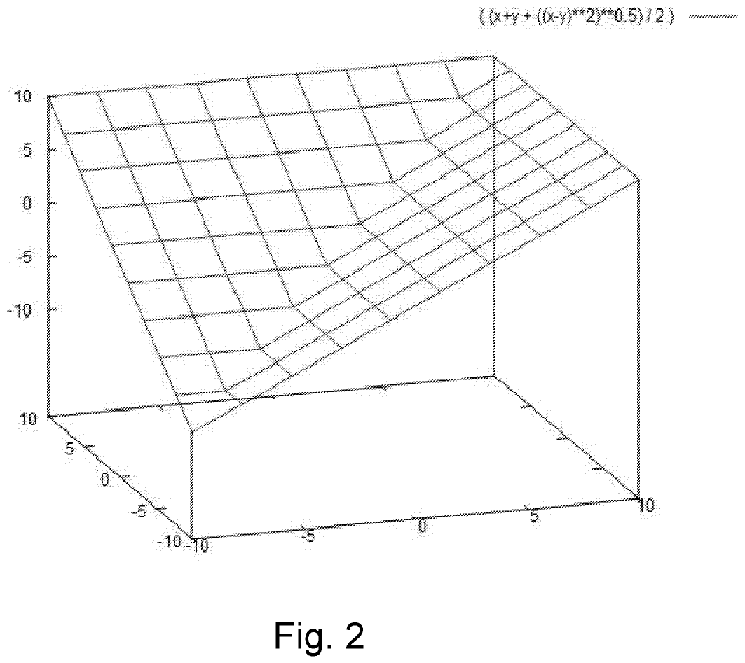

The function provides an approximation near any values of x and y, which is an advantage over Taylor or Chebyshev approximations, that are developed according to a specific point. Despite its simplicity, equation (2) provides a relatively good approximation, as shown in FIG. 2.

Using a two-variable function for the max pooling layer of k inputs requires chaining of the max functions:

max(x₁, x₂, . . . xₖ)=max(x₁, max(x₂, . . . , max(xₖ₋₁, xₖ))).

Alternatively, the optimization sequence is interrupted at the max-pooling layer, which will require an MPC protocol for the max function calculation, as described, for example, in [15].

### Example of an Efficient MPC Scheme

A protocol that meets the above requirements is introduced as part of a full MPC scheme. For the calculation of polynomial the Add.split procedure is used, shown below in Algorithm 1 for completeness.

Add.split procedure: given an element s∈ [symbol] ₚ, where [symbol] ₚ is a finite field containing p-primer elements, the procedure returns k additive secret shares whose sum is s.

p-prime number, s∈ [symbol] ₚ—a secret to share and k∈ [symbol] . Y₁, . . . , Yₖ₋₁←—randomly chosen from [symbol] ₚ Yₖ←s−Σᵢ₌₁^{k-1}Y₁(Y₁, . . . , Yₖ)—a sequence of secret shares of s.

Specifically, Add.split procedure is a perfectly-secure secret sharing scheme with threshold N−1. Each party calculates the polynomial known to it and sends the results to other parties. A sum of all results will be the result of the polynomial activation on the given input.

Add.split protocol generates a set of secret shares which are distributed among the k parties. The polynomial is calculated as follows:

### MPC Protocol of a Polynomial Function

given a polynomial p of degree d and input value x, the protocol calculates the value of p(x) using k participating parties: C₁, . . . , Cₖ, such that no party learns p.
p←Σᵢ₌₀^{d}aᵢxⁱ aᵢ in p (Y₁ⁱ, . . . , Yₖ₋₁ⁱ)←—Add.Split(aᵢ) aᵢ in p
Send Ci←(Yᵢ¹, . . . , Yᵢ^{d}) pᵢ←Σⱼ₌₀^{d}Yⱼⁱx^{j} Cᵢ
Send Cᵢ←x Cᵢ
Receive pᵢ(x)←Cᵢ Σᵢ₌₀^{d}pᵢ(x).

The protocol generated additive secret shares for every polynomial coefficient and distributes those shares among participating parties. This round can be done once in several calculations. The next step is sending the input x to the parties and receiving the output of polynomial activation of each party i: pᵢ(x). The final result is the sum of the received output.

This algorithm requires two rounds of communications per input and an additional round of secret sharing. The amount of data transferred by the algorithm is linear with respect to the polynomial degree, which makes the algorithm very efficient.

### Long Short-Term Memory (LSTM)

LSTM is a subset of Recurrent Neural Network (RNN) architecture, whose goal is to learn sequences of data. LSTM networks are used for speech recognition, video processing, time sequences, etc.

There are many different variations of LSTM units with a usual structure, including several gates or functions, which enable the unit to remember values over several cell activations. A common activation function of LSTM units is the logistic sigmoid function.

### Multiple Layers Approximation

As an approximation of multiple layers increases the degree of the polynomial function, the present invention provides possible techniques to use (intermediate) communication to keep the degree low. The DNN may be approximated with a single polynomial on a single computing node. Since the approximation exists for all the common activation functions, it is possible to combine multiple layers into a single polynomial function according to the connectivity of the layers.

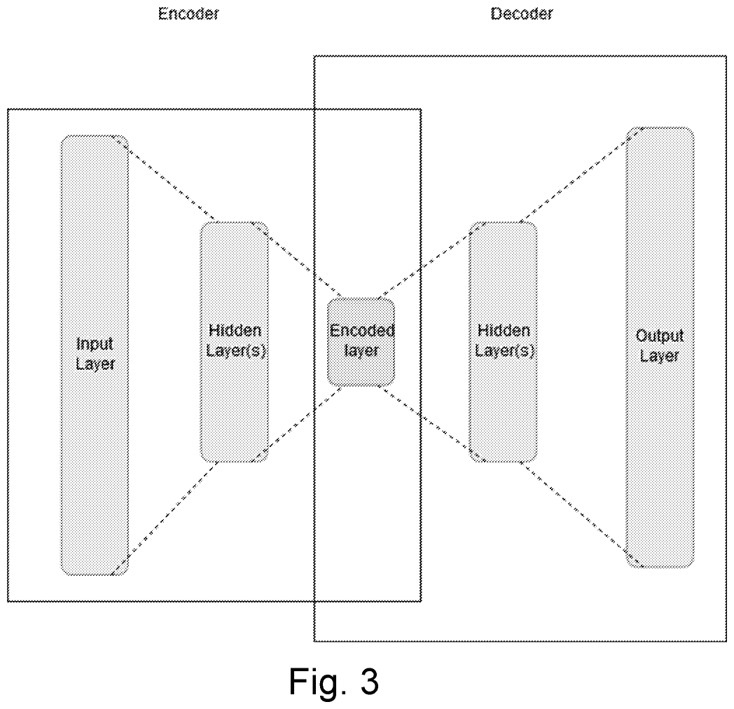

FIG. 3 shows a simple example of a high-level architecture of the auto-encoder neural network, that can be approximated by a single polynomial function, where hidden layers are dense layers with (commonly) ReLu or sigmoid activation. The encoder transforms data from the original dimension to a much smaller encoding, while the decoder performs the opposite operation of restoring the original data from the encoded representation.

This is done by creating a polynomial for the “flow” of the data in the network instead of approximating every single neural unit with a polynomial.

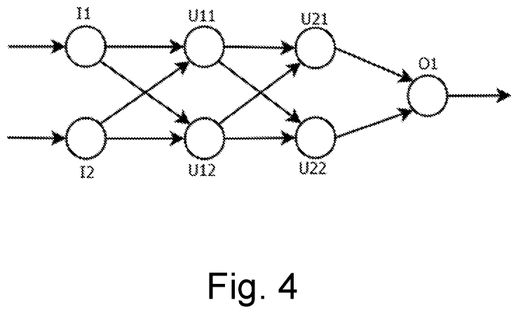

FIG. 4 shows an example network with an input layer on the left, two dense hidden layers U1 and U2, and an output layer on the right, consisting of a single unit. Each layer utilizes ReLu or sigmoid activation functions, or any other function that can be approximated by a polynomial.

In this example, the network consists of an input layer (I) on the left, two dense hidden layers (U₁ and U₂), and one output layer O, which is implemented by the softmax function. The units are marked as uₗᵢ where l is the hidden layer number and i is the number of the unit in the layer. It is assumed that the activation functions of the hidden layers are ReLu (or any other function that can be approximated by a polynomial function).

A unit u₁₁ calculates the function which is approximated by the polynomial. Assuming that ReLu activation functions are approximated using a polynomial of d-degree:

ReLu(ΣᵢwᵢIᵢ)≈P₁₁=Pol₁₁(ΣᵢwᵢIᵢ). (3)

Unit u₂₁ receives P₁₁ and P₁₂ as inputs and calculates the “nested” polynomial function:

P₂₁=Pol₂₁(ΣᵢwᵢP₁ᵢ). (4)

Generally, assuming dense layers, the nested polynomials are defined as:

Pₗⱼ=Polₗⱼ(ΣᵢwᵢP₍ₗ₋₁₎ᵢ). (5)

In this simple case, the result of networks evaluation can be calculated by evaluating two polynomials of d²-degree: P₂₁ and P₂₂, and calculating the output layer function of their output. Overall, by approximating softmax by Pol^{sm}, the following polynomial for the entire network is obtained:

DNN(x)=Pol^{sm}(w₁^{o}P₂₁+w₂^{o}P₂2)=Pol^{sm}(w₁^{o}Pol₂₁(w₁²¹P₁₁+w₂²¹P₁₂)+w₂^{o}Pol₂₂(w₁²²P₁₁+w₂²²P₁₂))=Pol^{sm}(w₁^{o}Pol₂₁(w₁²¹Pol₁₁(w₁¹¹I₁+w₂¹¹I₂)+w₂²¹Pol₁₂(w₁¹²I₁+w₂¹²I₂))+w₂^{o}Pol₂₂(w₁²²Pol₁₁(w₁¹¹I₁+w₂¹¹I₂)+w₂²²Pol₁₂(w₁¹²I₁+w₂¹²I₂))) (6)

P₁₁ and P₁₂ were calculated twice as they are used as inputs for both U₂₁ and U₂₂ units.

Non-dense layers are approximated in a similar way but with only the corresponding inputs from the previous layer. An example of such architectures is CNN, commonly used for image recognition. CNN layers have a topographic structure, where neurons are associated with a fixed two-dimensional position that corresponds to a location in the input image. Thus, each neuron in the convolutional layer receives its inputs from a subset of neurons from the previous layer, that belong to the corresponding rectangular patch. For the polynomial approximation of such networks, the polynomial approximating the unit depends only on the relevant units from the previous layer. In case when the interconnections of the networks, part of the architecture, are part of a secret as well, the network is considered to be dense, but the weights of the “pseudo”-connections are set to zero, thereby, achieving the same effect as not connecting the units at all.

### Decreasing the Polynomial Degree by Nesting

Neural units' calculation is the most common operation in the DNN feed-forward operation. The approximation of the operation with polynomial significantly increases the complexity of the activation function. For instance, ReLu function is in its essence a simple if condition, and is approximated with a 30-degree polynomial.

The impact is less severe than expected, as the approximation is applied to the networks after their training phase, which is extremely computationally intensive. However, it is still significant if many inference calculations are performed. In a multi-layer polynomial approximation, the degree of polynomials increases leading to an increase of performance overhead as well.

In order to limit polynomial degree at layer l, the polynomials from l−1 layer are not explicitly expanded into a single function (see Equation 5), but rather kept as a sum of lower-degree polynomials. In this way, each polynomial Pᵢⱼ is calculated only once in the process of the calculation of each multi-layer polynomial. This will limit the degree of the polynomial and eliminate redundant calculations.

### Hiding the Network Architecture

In case the network architecture in itself is valuable, it might be desired to conceal the correct architecture from cloud providers. The naïve multi-layer polynomial approximation hides the network architecture somewhat, even though, the degree of the polynomial might be a telling factor.

A way to conceal the exact network architecture is to add “pseudo”-nodes to the network. Those nodes will not contribute to the network inference but will add noise to the network architecture.

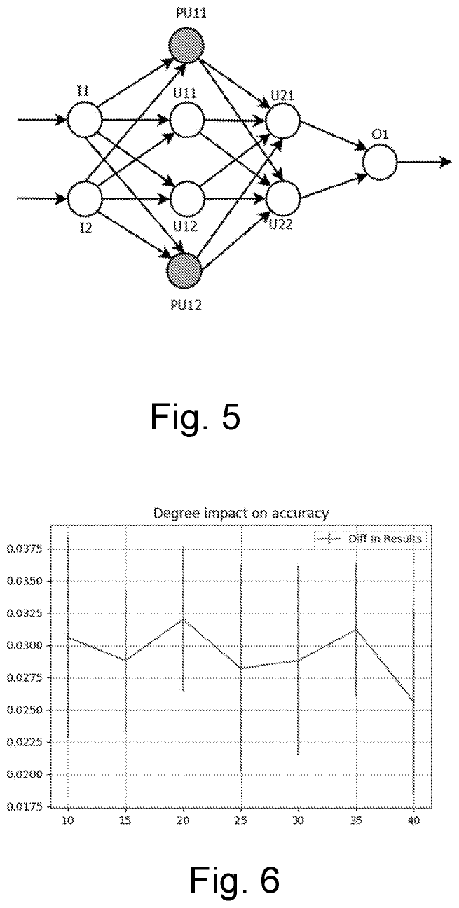

FIG. 5 shows an example of a network with pseudo-units of a simple network of FIG. 4 with two added pseudo-units: PU11 and PU12. The units are connected just like units of the dense layer, with input from all units of the previous layer and output connected to all units of the next layer. To nullify the influence of the pseudo-units on the network inference, the results of those units activation have to be canceled. A better way is to nullify an output edge weights, rather than input connection. This way, it is possible to ensure that memory-enabled units or custom-activation units will not contribute. In the example, the edges: PU11→U21, PU11→U22, PU12→U21 and PU12→U22 will be zeroed.

The location of the units is randomized and the number of the units depends on the need to hide the original network architecture.

### Communication-Less MPC for Polynomial Calculations

The MPC calculations is to protect the published model from exposure to participating cloud providers. The model is trained by the data provider and has two components: architecture, which includes the layout, type, and interconnection of the neural units, as well as the weights of the input, which were refined during the training of the network, i.e., during a back-propagation phase.

It is required to protect the weights that were obtained by a costly process of training. While the architecture also might hold ingenious insights, it is considered less of a secret and may be exposed to the cloud providers.

Any MPC protocol can be used, preferably if it is compatible with the following requirements:
The protocol calculates polynomials over k participating parties. The goal is to spread the calculation over many servers/cloud providers to minimize the risk of adversaries' collaboration. Therefore, the protocol should preferably support k>2 parties.
Perfect Information theoretically secure protocol.
Efficient calculation of the polynomial in terms of communication rounds to enable usage of high-degree polynomials.

A number of existing MPC protocols answer those requirements [2, 4]. These MPC protocols based on Shamir secret sharing [14] can cope with a minority of semi-honest parties and even with a third of the malicious parties. BGW protocol [2] provides perfect security and [4] provides statistical security with any desirable certainty. In this case, the input is not a multi-variable that is secret-shared, but rather the weights and coefficients of the network are the secrets.

### Clear-text Inputs

In a first scenario, the input is revealed to all participating parties. In this case, the secrets are the weights of the trained network. The input values can be considered as numerical constants for the MPC calculation and thus, communication rounds can be eliminated completely (see BGW [2] algorithm where additive “gates” are calculated locally without any communication).

Given a secret-share of coefficient a: s=[s₁, s₂].The polynomial p(x) can be calculated as p(x)=p₁(x)+p₂(x), where p₁(x) and p₂(x) use the corresponding secret share.

### Secret-Shared Inputs

In the second scenario, the input values are protected as well, and thus, they are distributed by secret sharing. As the input values are raised to polynomial degree k, secret sharing is done on the set of values: X=[x, x², . . . x^{k}]. Multiplication of secret shares generally requires communication rounds, still when secret sharing every element of X, it is possible to eliminate the communications all-together using the method described in [3]. Nested polynomials cannot be used in this case, since the polynomial terms have to be regrouped for nesting, and secret-sharing of inputs prevents that.

### Distributed Communication-Less Secure Interference for Unknown DNN

The present invention also provuides the techniques for blindly computing a polynomial (i.e., some of its coefficients being secret shares of zero), to obtain blind execution of DNN. Since the neural network activation functions are not limited to a specific set, there might be networks that cannot be approximated. However, the majority of networks use a rather small set of functions and architectures.

Once the neural network is presented by a single polynomial it can be calculated without a single communication round (apart from the input distribution and output gathering) when the inputs are revealed, or with half the communication rounds when the inputs are secret. Therefore, the data owner can train DNN models, pre-process, and share them with multiple cloud providers. The providers then can collaboratively calculate interference of the network on common or secret-shared inputs without ever communicating with each other, thereby reducing the attack surface even further even for multi-layer networks.

Moreover, the data owner may sell the rights similarly to a Non-Fungible Token (NFT—a non-interchangeable unit of data stored on a blockchain, a form of digital asset on a ledger, that can be sold and traded), on the data model to others. This in turn, can be regarded as an executable cryptocoin (cryptocoin is a digital currency designed to work as a medium of exchange through a computer network), DNNCoin where the digital asset is a DNN network and the service it can provide,cryptocoin that provides udseful output with Blockchain registered owner. Other executable NFTs and cryptocoins can be based on executable-NFTs/executable-cryptocoin framework proposed by the present invention, and can be traded in the (crypto) market. For example, stock recommendation, executable-NFTs/SRCoin where the coin provide service of Stock Recommandation, Psychological Advisor executable-NFTs/PACoin, where the coin provide Psychological Advising service, and even entertaining jumping cat, where animated creature reacts to requests executable-NFTs/JCCoin such as a Jumping Cat.

The present invention also provides a method for managing a trained data model of a neural network, by allowing a blockchain registered data owner to sell the rights on the data model services and/or at least a part of the ownership to other parties by representing the owned data as an executable cryptocoin (such as DNNCoin, SRCoin, PACoin, JCCoin, stock recommendation executable, psychological advisor executable, entertaining jumping cat executable), in order to provide beneficial reaction to requests.

### Fully Homomorphic Encryption Alternative

In this embodiment, the proposed polynomial neural network representation facilitates an efficient execution of the inference by an untrusted third party, without revealing the machine learning (big) data, the queries, and the results.The reduction of Neural Networks to nested polynomials, facilitate inference over encrypted polynomial coefficients and encrypted inputs using computational secure (unlike the perfect information theoretic secure of the other scheme proposed here) Fully Homomorphic Encryption (FHE) [8]. The nested polynomial that represents fully connected layers can still be calculated in polynomial time (the total number of connections is quadratic in the number of every two layers of neurons), so some of the encrypted coefficients (or edge weights) can be an encrypted zero which in fact yields an (unrevealed) subset of the Neural Network.

Accordingly, by using FHE and the nested polynomial, it is possible to perform delegation of machine learning to a third party (e.g., a cloud provider) without revealing anything about the (big) data (collected), the inputs/queries, and the outputs. For example, when the neuron computes the max function, the nested polynomial can integrate actual FHE computation of the max over the inputs arriving from the previous layer, rather than a polynomial over these inputs. A neuron is computed as polynomial over input polynomials (values), and two (or more) results can be computed for each neuron: one a polynomial over the inputs to the neuron and one an FHE max value over the input. Then an encrypted bit(s) is used to blindly choose among the results, i.e. between polynomial or “direct” FHE calculation of the neuron activation function.

FIG. 6 shows the difference in accuracy of the network with different degrees. A graph of the inuence of polynomial degree on the network accuracy. The X-axis shows the degree of the polynomial approximation and the Y-axis shows the accuracy difference over 500 samples averaged over 10 runs. As can be seen, the accuracy improves with the degree of the polynomial approximation, however the improvement flattens at around d=30.

The computation costs are increasing linearly with the polynomial degree (data not shown), where the original ReLu is similar to d=1 degree polynomial. Thus, it makes sense to choose the lowest degree that still provides consistent and accurate results.

The present invention is also directed to a Statistical Information Theoretic Secure (SITS) system utilizing Chinese Remainder Theorem (CRT—a theorem that states that if one knows the remainders of the Euclidean division of an integer n by several integers, then one can determine uniquely the remainder of the division of n by the product of these integers, under the condition that the divisors are pairwise coprime, such that no two divisors share a common factor other than 1) coupled with Fully Homomorphic Encryption (FHE) for Distributed Communication-less Secure Multiparty Computation (DCLSMPC) of any Distributed Unknown Finite State Machine (DUFSM). Accordingly, secret shares of the input(s) and output(s) are passed to/from the computing parties, while there is no communication between them throughout the computation.

The present invention also provides a transition table representation and polynomial representation for arithmetic circuits evaluation, joined with a CRT secret sharing scheme and FHE to achieve SITS communication-less within computational secure execution of DUFSM. FHE implementation has a single server limitation to cope with a malicious or Byzantine server. Several distributed memory-efficient solutions that are significantly better than the majority vote in replicated state machines are used, where each participant maintains an FHE replica. A DUFSM is achieved when the transition table is secret shared or when the (possible zero value) coefficients of the polynomial are secret shared, implying communication-less SMPC of an unknown finite state machine.

The processing of encrypted information where the computation program is unknown is an important task that can be solved using communication among several participants. However, this communication reveals the participants to each other and requires a non-negligible overhead concerning the communication between them. Computational secure communication-less approaches can also be suggested, either for the case of known automaton and global inputs, or for the case of computational security alone. Here, the first communication-less solution that is statistical information-theoretical secure, with (FHE-based) computational secure scheme is presented.

Distributed computing uses replicated state machines, which is implemented based on a distributed consensus [22]. The present invention also provides a sharing scheme that is based on a secret shared transition function or a unique polynomial over a finite ring for implementing e.g., Boolean function, state machine transition, control of RAM, or control of Turing Machine.

For any state machine, this polynomial encodes the information of all the transitions from a state x and input y to the next state z. The information may also contain the encoding of the output. Once the polynomial is adjusted, it is described by an arithmetic circuit that can be evaluated distributively by the SMPC participants. Each participant evaluates the arithmetic circuit using the CRT-SITS secret sharing scheme where the shares are encrypted using FHE. Consequently, the possibility for (value secured) additions and multiplications with no communication is achieved. This polynomial representation of the transition function keeps the actual computed function private by using secret shares for all (zero and non-zero) coefficients of the polynomial, while revealing only a bound on the maximal degree k of the polynomial.

The CRT representation allows independent additions and multiplications of the respective components of two (or more) numbers over a finite ring. This way, it is possible to compute arithmetic circuits in a distributed fashion, where each participant performs calculations over a finite ring defined by the (relatively) prime number they are in charge of. Thus, a distributed polynomial evaluation is obtained, where several participants do not need to communicate with each other.

The transition function of a state machine may be represented by a bi-variate polynomial from the current state and the input to the next state (and output). Namely, a bi-variate polynomial can be defined by the desired points that define the transition from the current state (x) and the input (y) to the next state (z), which may encode the output, as well. Alternatively, a univariate polynomial can be defined by using the most significant digits of (x+y) to encode the state (x) and the least significant digits, to encode the input (y). The output state (z) occupies the same digits of (x) that serve to encode the next state, while the rest of the digits in (z) are zeros. Thus, the next input can be added to the previous result and be used in computing the next transition, and so forth.

By using the scheme of the present invention, a more efficient version of the replicated state machine (and Blockchain) can be implemented, with only a logarithmic-sized memory compared to the legacy replicated state machine.

Naturally, several known error correction techniques that rely on features of the CRT (depicted in [19],[20]) can eliminate the influence of Byzantine participants. These schemes are not designed to preserve the fully homomorphic property of CRT secret sharing, just as the CRT threshold secret sharing does not support additions and multiplications as the values can exceed the global maximal value the (original, with no additional error-correcting values) mutual primes can represent. Still, when using FHE, a computation can be designed to never exceed this maximal value and be error corrected.

A distributed secure multiparty computation may be preferred when FHE is executed over a single server (since the server can be Byzantine).

Recently, extensive work on computationally secure communication-less computation has been done, see [14, 9] and in references therein. However, the computation security

is only based on the belief that one-way functions exist [10]. Several other works in the scope of perfect information-theoretically secure schemes were presented in [13, 15, 12, 5, 16]. Unfortunately, neither of them can compute all possible functions, and they require either communication or a need for exponential resources to maintain continuous functioning. Function secret sharing (FSS) is described in-depth in [8], and provides an efficient solution for MPC. However, the suggested scheme relies on secret keys and random masks that are applied to the inputs. While both techniques reflect computational difficulty, there is no backup in the form of SITS, in case the secret key is revealed or the Pseudo Random Generator (PRNG) is not sufficient. The suggested scheme is an alternative to a replicated state machine with no communication, while improving the communication overhead of the secret shared random-access machine presented in and the secret shared Turing machine presented in [13].

This SITS within FHE approach can also be used in implementations for distributed, efficient, databases [3], Accumulating Automata with no [15] communication or even for ALU operations in the communication-less RAM implementation [17].

### CRT Arithmetic

Let p₁<p₂<. . . <pₖ where pᵢ are relatively prime and a set of congruence equations a≡aᵢ(modpᵢ) for 1≤i≤k for k>0 and where aᵢ are remainders. The original form of the CRT states that this given set of congruence equations always has one and exactly one solution modulo Π₁^{k}pᵢ.

The most important feature of the CRT, is the possibility of independently adding and multiplying two vectors of congruence values, for performing fully homomorphic (addition and multiplication) operations on CRT-based secret shares. Unlike perfectly secure secret sharing (such as the schemes of Shamir [27] and Blakley [6]), CRT-based secret sharing that supports homomorphic additions and multiplications (unlike [2]) is only statistically secured. The present invention uses FHE to computationally mitigate information leakage from the individual CRT share.

### Secure Multiparty Computation

The effectiveness of a joint secure operation is detailed in [21], introducing a series of arithmetic calculations, done over a finite field. The solution is perfect information-theoretic secure but requires communication among the participants to support polynomial degree reduction after a multiplication.

The CRT-based Secure Multiparty Computation proposed by the present invention is only statistical information-theoretic secure, but at the same time, uses significantly less memory per participant and enables communication-less operations.

The calculation results of each participant can be collected and recovered into a unique result in [symbol] _{K} where K=Πᵢ₌₁^{k}pᵢ. The task of reducing all the results into a single solution can be performed by some known algorithms, such as Garner's Algorithm [24], which is used by the present invention.

In case of two n-bit numbers x, y that are multiplied distributively among k parties, the series of calculations is only 1-multiplication-long, so the result is bounded by 2²ⁿ. First k primes whose product is large enough (line 2) are found, so the CRT recovery is possible. Then, all k primes are distributed to the parties, such that every party holds a different prime modulus (line 2). In this example, the calculation results are collected synchronously. Actual multiplication results are ecovered using Garner's algorithm (line 13).

```
Algorithm 1: Distributed Multiplication Example
    input : integers x, y, number of parties n
    output: the result of x · y
  1 K ← 2^{|x|+|y|} ;  // define highest bound
    // find k prime numbers whose product is greater than 2²ⁿ
  2 for bound ← 2 to K do
  3 | primes = findPrimes(k, bound) ; // find k primes up to bound
  4 | if production(primes) > K then
  5 | | break;
  6 | end
  7 | bound ← bound + k ; // try find primes with higher bound
  8 end
  9 for i ← 1 to k do
10 | m ← primes[i];
11 | results[i] ← sendParty(m, multiply, x,y) ; // x · y (mod m)
12 end
18 result ← garner(primes, results);
14 return result.
```

The square of x=14 can be distributively computed by a group of 3 parties. Each party calculates the multiplication of x with itself such that:

$$\\ \begin{matrix}x & ( mod 5 ) = 4 \\ x & ( mod 7 ) = 0 \\ x & ( mod 11 ) = 3\end{matrix} \} \begin{matrix}4 \cdot 4 ≡ 1 & ( mod 5 ) \\ 0 \cdot 0 ≡ 0 & ( mod 7 ) \\ 3 \cdot 3 ≡ 9 & ( mod 11 )\end{matrix} \} x \cdot x ≡ 196 ( mod 385 )$$

the result of Garner's algorithm is y=196∈ [symbol] /385 [symbol] where:

y=196=1+4·5+5·(5·7) (2)

Which satisfies the following as expected:

y≡1(mod5), y≡0(mod7), y≡9(mod11), (3)

The result of the calculation did not exceed the size of [symbol] /385 [symbol] . Specifically, in case that the result of a calculation does overflow the ring bounds (the maximal product value of the moduli, 5·7·11=385 in this example), an unexpected result in the recovery step may occur. This result is guaranteed to be the modulo reduction of the correct one with respect to the moduli product value, thus it might still be useful. Nevertheless, this problem can be resolved by adding more parties to the computation, or by choosing larger primes. While both options increase the ring's bounds, thereby preventing a calculation overflow, the first option is preferable as it has no penalty on the total memory usage.

Therefore, in the general case where a distributed calculation is carried out for some operator/function, one may follow the dealer-worker scheme. In this scheme, there is a single party that is responsible for the assignment of jobs and collection of the results while other parties have no responsibility besides the calculation itself. The first party is denoted as the “dealer” in this scheme and the other parties as “workers”.

The following Algorithm 2 and Algorithm 3 respectively describe their procedures. Initially, the dealer generates the appropriate primes (line 2) and distributes them to the workers (line 2). Throughout the computation, the dealer manages a queue that is shared with the workers in such a manner that every time an input arrives, it is pushed to the queue (line 2) and popped in turn by the workers. Thanks to this queue, the dealer can start and stop each worker asynchronously (line 2), and by that can be more efficient. The dealer ultimately recovers the result using a recovery function of their choice (line 2).

```
Algorithm 2: Dealer Procedure
    input : initial value x, an operation op, and a stream of inputs stm
    output: result of op applied on x with all the inputs in stm
    // generate primes for all the workers, K is chosen in advance to guarantee the
      result does not overflow
  1 primes ← genPrimes(K);
    // initialize an empty queue
  2 q ← queue( );
    // start all workers with their modulo and the queue
  3 for i ← 1 to K do
  4 | m ← primes[i];
  5 | workers[i] ← startWorker(m, op, mod(x, m), q);
  6 end
  7 while hasNext(stm) do
      | // start pushing inputs to the queue
  8 | q.push(next(stm));
  9 end
      // stop all workers and collect their results
10 for i ← 1 to K do
11 | results[i] ← stopWorker(workers[i]);
12 end
      // recover the final result
13 return recover (primes, results)
```

```
Algorithm 3: Worker Procedure
  input : modulus m, operation op, initial value x, and inputs queue q
  output: result of op applied on x and all the inputs
1. while notSignaled( ) do
2 | y ← tryPop(q);
3 | x ← op(x, y) (mod m);
4 end
5 return x
```

The operation is always executed with respect to the unique modulus, such that there is no risk of overflow, or exceeding the finite field by the computation. The computation's limit is defined by the maximal number that the CRT shares represent, thus keeping the whole memory footprint small during the process.

### Replicated State Machine vs. CRT DFSM or DUFSM

The present invention provides a DFSM approach that copes with several of the RSM drawbacks. To increase the privacy of the computation implied by this approach, suggest a local FHE based arithmetic circuit is used, that keeps the efficiency of memory while protecting the data.

### Implementing the Transition Function with Secret Sharing

An Arithmetic Circuit is based on additions and multiplications which support the implementation of any FSM transition function or table. One convenient way to do so is by representing each bit in the circuit as a vector of two different bits (just as a quantum bit is represented). Namely, the bit 0 is represented by 01, and the bit 1 by 10. If each directed edge in the transition function graph tuple representation being represented as [symbol] CurrentState, Input→NextState, Output [symbol] , then, given a (possibly secret shared) transition function, this structure allows to secret share the table among different participants, possibly even padding it with additional never-used tuples. CurrentState, Input, and NextState are represented by a sequence of 2-bits vectors. Thus, the logarithmic number of bits needed for the binary representation is doubled, rather than using (optimized for small degree polynomial, secret shares, and multiplication outcome) a linear number of bits in the unary representation as used in

[13].

In order to blindly compute the next state and output, given the current state and input, a participant multiplies each bit of the shared secret (2-bits vector representation) with the bits of each line of the transition table. Then, they sum up the resulting 2-bits vector into a single bit. For example, for the binary representation of the current state 110, the 2-bits vector representation is 101001.

Example of transition function representation:

[symbol]

010101,01→010101,442

[symbol]

[symbol]

010101,10→101001,065

[symbol]

[symbol]

101001,01→101001,542

[symbol]

[symbol]

101001,10→010101,324 [symbol] (4)

Note that only two inputs are possible in the example here, either 0, represented by 01, or 1, represented by 10. Furthermore, the output can be agreed to be represented in binary, and express a number inside the finite ring of the CRT secret sharing. For example, when three participants are using the primes 3<11<19, then the finite ring being used for the secret sharing is 627. While the states and inputs representations are optimized for logical matching through arithmetic operations, the output representation can benefit from being memory efficient.

In case the current secret shared state and inputs are 101001 and 01 respectively, the next state and output are found by multiplication of every bit of the 2-bits vectors with each line of the table. Namely, the first two bits 10 of the current state are multiplied by the first two bits 01 in the table, resulting in 1·0=0 and 0·1=0, obtaining together 00. Then, by summing the two resulting bits, 0 is obtained, which (blindly) indicates that there is no match. However, the third line in the table yields a match, as a sum of 1 is obtained from the first two bits (10 in the current state and 10 in the table), same for the next two bits 10 and the last two bits 01, altogether yielding the desired output. Finally, if the input is 01, then the third line matches completely, as also the input matches by yielding 1. Therefore, only the third line of the table yields results consisting of only 1 bits that when are (blindly) multiplied among themselves result in 1.

```
Algorithm 4: Blindly Matching a Transition Tuple
    input : transition table T, state current with length L and input i
    output: next state and output
  1 x ← encode(current) ;  // encode in the redundant form
  2 y ← encode(i);
  3 result ← 0
  4 foreach line in T do
  5 | xT ← line[0] ; // unpack each tuple
  6 | yT ← line[1];
  7 | sum ← 1;
  8 | for i ← 0 to 2L do
      | | // perform multiplication with previous and current sum (i += 2)
  9 | | sum ← sum · (x[i] · xT[i] + [i + 1] · xT[i + 1]);
10 | end
11 | sum ← sum · (y[0] · yT[0] + y[1] · yT[1]);
12 | result ← result + sum · T[line] ; // accumulate conditioned next state
13 end
14 return decode(result)
```

### Utilization of an FHE Mechanism

FHE scheme is an encryption scheme that allows the evaluation of arbitrary functions on encrypted data. The problem was first suggested by Rivest, Adleman, and Dertouzos [25], and thirty years later, implemented in [18]. A major application of FHE is in cloud computing. This is because a user can store data on a remote server that has more storage capabilities and computing power than theirs. However, the user might not trust the remote server, as the data might be sensitive, so they send the encrypted data to the remote server and expect it to perform some arithmetic operations on it, without learning anything about the original raw data. The present invention uses an FHE scheme to preserve the privacy among the participants, each being a remote server, blindly following the computation process.

The dealer's procedure described in Algorithm 3 is extended to support FHE behavior. The dealer initializes an FHE context with which they encrypt both the initial value and the incoming inputs (lines 6,11). From this point, they continue in the same way as before (line 7,12), except for a decryption step at the end (line 16) and scheduled bootstrapping steps during the computation. For the sake of generality, the bootstrapping step is omitted but can be regarded as the assignment of the first share of the input to be the share of the initial state. After completing all of the decryptions, the results are reassembled by the CRT into a single solution, as shown before.

Equally, the participants (workers) are dealt with a plaintext modulus in which they operate. By keeping the modulus in the clear, any meaningful information is not leaked and the participant is aided in carrying out the computation with respect to their finite field. As before, after a worker is initialized, they start receiving encrypted inputs and apply the operator to them (line 3). As opposed to the operator application in a general field, these blind applications are expected

```
Algorithm 5: Dealer Extended FHE Procedure
    input : initial value x, an operation op, and a stream of inputs stm
    output: result of op applied on x with all the the inputs in stm
  1 context ← initFHE( ) ;  // context allows encryption+decryption
  2 primes ← genPrimes(K);
  3 q ← queue( );
  4 for i ← 1 to K do
  5 | m ← primes[i];
  6 | xEncrypted ← encrypt(mod(x), context) ; // encrypt x (mod m)
  7 | workers[i] ← startWorker(m, op, x Encrypted, q);
  8 end
  9 while hasNext(stm) do
10 | y ← next(stm);
11 | y Encrypted ← encrypt(y, context) ; // encrypt incoming input
12 | q.push(yEncrypted);
13 end
14 for i ← 1 to K do
15 | r Encrypted ← stopWorker(workers[i]);
16 | results[i] ← decrypt(r Encrypted, context) ; // decrypt result
17 end
18 return recover(primes, results)
```

```
Algorithm 6: Worker Extended FHE Procedure
  input : modulus m, operation op, encrypted initial value x, and encrypted inputs queue q
  output: encrypted result of op applied on x and all the encrypted inputs
1 while notSignaled( ) do
2 | y ← tryPop(q);
3 | x ← op(x, y);
4 | x ← blindMod(x, m) ; // can be implemented in several ways
5 end
6 return x
```

to be done in a finite field that is typically different from the binary field in computers (e.g., 8 bits for BYTE or 32/64 for a computer WORD). Therefore, the worker performs a dedicated balancing step after each iteration (line 4). Namely, they perform a blind modulo reduction to the result, thus keeping it inside the field. This step is possible due to a unique feature of FHE bitwise calculations that allows a blind conditioned output.

One popular library that supports this feature is IBM's HELib [28]. This implementation is based on an aggregation of the condition results. Namely, if one wishes to blindly increment a number i by 1 in case it is negative, or otherwise, blindly decrement it, they should first implement an indicator function:

$$\\ \begin{matrix}I ( x ) = ( \begin{matrix}0 & x < 0 \\ 1 & otherwise\end{matrix} & ( 5 )\end{matrix}$$

Then, use this function in a context such that i′s value changes correctly:

F(x)=x+1·I(x)−1·(1−I(x)) (6)

A suggested implementation is outlined in the following algorithm. Line 3 creates an unknown bit and line 3 reflects a conditioned output based on that bit. The subtraction is aggregated by using the differences computed in line 3.

Algorithm 7 Blind Modulo Reduction

| | input : encrypted integer x, modulus m | |
|---|---|---|
| | output: result of encrypted x (mod m) | |
| 1 | levels ← maxLevels(m) ; | $// max possible value i . e ⌊ \frac{{( m - 1 )}^{2}}{m} ⌋ \approx m$ |

| 2 | for j ← 0 to levels do | |
|---|---|---|
| 3 | \| | i ← compare(x, m); |
| 4 | \| | d ← x − i; |
| 5 | \| | x ← xi · d + (1 − i) · x; |

| | |
|---|---|
| 6 | end |

Utilizing this feature is essential during the procedure of a worker in the proposed CRT based approach as the worker should be oblivious to the fact they carry out the same procedure only on encrypted data. As long as they know how to perform homomorphic operations such as additions and multiplications, while staying within the boundaries of the computer's binary representation, the homomorphism of the operations over the CRT secret shares is preserved.

### Polynomial Based CRT DUFSM

This embodiment further improves the secrecy of the transition function of the FSM that is based on polynomial representation.

### Polynomial Interpolation in Finite Rings

It is often useful (e.g., [26]) to estimate the value of a function y=f (x) at a certain point x based on some known values of the function, i.e., f(x₀), f(x₁), . . . , f(xₙ). These values are evaluated at a set of n+1 points a=x₀, x₁, . . . , xₙ=b in the range {a . . . b}. One way to carry out this operation is to approximate the function f(x) by an n-th degree polynomial:

$$\\ \begin{matrix}f ( x ) \approx {P}_{n} ( x ) = {a}_{n} {x}^{{}^{} n} + {a}_{n - 1} {x}^{{}^{} n - 1} + , … , {a}_{2} {x}^{{}^{} 2} + {a}_{1} x + {a}_{0} = {\sum }_{j = 0}^{n} {a}_{j} {x}^{{}^{} j} & ( 7 )\end{matrix}$$

where the coefficients a₀, . . . , aₙ are obtained based on the n+1 given points. Specifically, to find the coefficients of Pₙ(x), it is required the polynomial to pass through all the points: {(xᵢ, yᵢ)=f(xᵢ)|i=0, . . . , n} so that the following n+1 linear equations hold:

$$\\ {P}_{n} ( {x}_{0} ) = {\sum }_{i = 0}^{n} {a}_{i} {x}_{0}^{{}^{} i} = f ( {x}_{0} ) = {y}_{0}$$

$$\\ {P}_{n} ( {x}_{1} ) = {\sum }_{i = 0}^{n} {a}_{i} {x}_{1}^{{}^{} i} = f ( {x}_{1} ) = {y}_{1}$$

$$\\ =$$

$$\\ {P}_{n} ( {x}_{n} ) = {\sum }_{i = 0}^{n} {a}_{i} {x}_{n}^{{}^{} i} = f ( {x}_{n} ) = {y}_{n}$$

This polynomial Pₙ(x) can be obtained by the interpolation polynomial in the Lagrange form. This polynomial is defined as a linear combination denoted by:

Lₙ(x)=Σᵢ₌₀ⁿyᵢlᵢ(x) (8)

where lᵢ(x) is the Lagrange basis polynomial of degree n, that together with the other basis polynomials span the space of all n-th degree polynomials:

$$\\ \begin{matrix}{l}_{i} ( x ) = {\prod }_{j = 0 , j \neq i}^{n} \frac{x - {x}_{j}}{{x}_{i} - {x}_{j}} = \frac{( x - {x}_{0} ) … ( x - {x}_{i - 1} ) ( x - {x}_{i + 1} ) … ( x - {x}_{n} )}{( {x}_{i} - {x}_{0} ) … ( {x}_{i} - {x}_{i - 1} ) ( {x}_{i} - {x}_{i + 1} ) … ( {x}_{i} - {x}_{n} )} & ( 9 )\end{matrix}$$

when x=xⱼ for j=0, . . . , n, then:

$$\\ \begin{matrix}{l}_{i} ( {x}_{j} ) = {δ}_{ij} = ( \begin{matrix}1 & i = j \\ 0 & i \neq j\end{matrix} & ( 10 )\end{matrix}$$

This way, the polynomial Lₙ(x) passes through all n+1 points, because:

$$\\ {L}_{n} ( {x}_{0} ) = {\sum }_{i = 0}^{n} {y}_{i} {l}_{i} ( {x}_{0} ) = {\sum }_{i = 0}^{n} {y}_{i} {δ}_{i 0} = {y}_{0} = f ( {x}_{0} )$$

$$\\ {L}_{n} ( {x}_{1} ) = {\sum }_{i = 0}^{n} {y}_{i} {l}_{i} ( {x}_{1} ) = {\sum }_{i = 0}^{n} {y}_{i} {δ}_{i 1} = {y}_{1} = f ( {x}_{1} )$$

$$\\ =$$

$$\\ {L}_{n} ( {x}_{n} ) = {\sum }_{i = 0}^{n} {y}_{i} {l}_{i} ( {x}_{n} ) = {\sum }_{i = 0}^{n} {y}_{i} {δ}_{i n} = {y}_{n} = f ( {x}_{n} )$$

This polynomial is only an approximation of f(x) in certain points. So, in fact, at any other point x≠xⱼ for j=0, . . . , n, the polynomial value is unpredictable.

Conceptually, polynomial interpolation in finite rings should not differ from polynomial interpolation in general rings such as [symbol] . That is because modular arithmetic can be used instead of regular arithmetic, thereby following a standard interpolation algorithm.

In case of using the Lagrange interpolation, it is essential to choose the parameter M>0 of the ring [symbol] /MZ wisely. Otherwise, the interpolation fails. Since it is not guaranteed that every number x∈ [symbol] /MZ is invertible (e.g, zero), and the denominators in the basis polynomials are comprised of differences between two numbers, the different divisions might not be possible. Therefore, for a set of points {(xᵢ, yᵢ)|i=0, . . . , n}, it is crucial to choose such ring [symbol] /MZ, where all the differences xᵢ−xⱼ are invertible.

Given a set of points in the finite ring [symbol] /KZ, such that K=Πᵢⁿpᵢ for relatively primes pᵢ, to successfully interpolate this set of points using Lagrange's method, it is required to verify that neither of the differences has a common factor in {p₁, . . . , pₙ}.

If there exist i≠j such that the difference d=xᵢ−xⱼ has a prime factor p_{d}∈{p₁, . . . , pₙ} then Lagrange's polynomial interpolation is not possible.

Proof:

By contradiction, if such p_{d} exists, then d=pᵢ_{₁}^{k}^{₁}, . . . , p_{d}^{k}^{_{d}}, . . . , pᵢ_{ₙ}^{k}^{ₙ} for k_{d}>0 and kᵢ≥0. In other words, the distance d can be represented as d=p_{d}^{k}^{_{d}}·N for some N≥1, and d=p_{d}^{k}^{_{d}}·N(modp_{d})≡0 holds. Thus, d is not invertible (although it is assumed that it is).

Algorithm 8 is used to choose the relatively primes p₁, . . . , pₖ before starting the interpolation process. First, all the differences that might not be invertible are found and factorized (line 5). Once all the factors to be avoided are obtained, primes that are coprime to these factors are found (line 12). Lastly, the prime set whose product is large enough (line 15) is returned.

If a given FSM is represented by a truth table, in the relations between the different states and the possible inputs or outputs interested. The present invention proposes a (non-perfect) encoding scheme that allows to represent this FSM completely by polynomials. First, the different states and transitions are encoded in some grid-compatible representation, where a transition in that context, is a 2-tuple e=(u, v) such that the state u has a valid input that leads to v. One simple encoding is through positive integers representation. Given a set of states V, and a set of transitions E, the 2-D point unique encoding of them is calculated, as follows in Alg. 9.

Since the y value of a point is comprised only of a state encoding, the decoding process is simple. It is however not guaranteed for the x value, as it is comprised of an encoded summation that might overlap other encoded values. One possible way to deal with this, is to simply work on different scales, more specifically, a factor f=10^{t} where t>0 is used to choose the integers in line 4 from the range {f+1 . . . |V|·f}. Also, considering that there might be many transitions to cause an overflow between the scales, the parameter t needs to be bounded such that t>log|E| and f=10^{t}>|E| holds.

```
Algorithm 8: Finding Interpolation Parameters in [symbol]   /K [symbol]
    input : set of points s = {(x₁, y₁), . . . , (xₙ, yₙ)} and a parameter k
    output: sequence of appropriate k prime integers p₁, . . . , pₖ or null
  1 for i ← 1 to n do
  2 | for j ← 1 to n do
  3 | | difference ← abs(s[i] − s[j]);
  4 | | foreach ƒ ∈ factorize(difference) do
  5 | | | factors.append(ƒ);
  6 | | end
  7 | end
  8 end
  9 for bound ← 2 to K do
10 | primes ← findPrimes(k, bound);
11 | if length(primes) < k or length (factors ∩ primes) > 0 then
12 | | continue;
13 | end
14 | if production (primes) > K then
15 | | return primes
16 | end
17 | bound ← bound + k;
18 end
19 return null
```

```
Algorithm 9: |FSM| Encoding Procedure
    input : V, E
    output: A list of points P₁ = (x₁; y₁), . . . . , Pₙ = (xₙ, yₙ) where n = |E|
  1 rangeV ← randRange(1, |V|) ; // generate numbers for each state
  2 rangeE ← randRange(1, |E|) ; // generate numbers for each transition
  3 points = [ ];
  4 for i ← 1 to |E| do
  5 | u-u ← unpack( E[i]) ; // unpack the states in transition
  6 | x ← rangeV |indexOf(u, V)] + rangeE[d];
  7 | y ← rangeV[indexOf(u, V)];
  8 | points.append((x, y));
      | /* each point P is calculated such that P = (rᵤ + rₑ, rᵥ) where rᵤ, rᵥ are the
      | random numbers chosen for states u, v and rᵤ is the random number chosen for
      | transition ϵ */
  9 end
10 return points
```

### Evaluating Polynomial within FHE

Since the polynomials are both encrypted and already evaluated in a specific field, the only information a participant can learn stems from the encryption parameters and the finite field modulus assigned to him beforehand. By keeping the modulus clear, the assignment process is simplified, while not revealing any meaningful data to the participants, as all the other data they receive is encrypted. The encryption parameters, however, including the public key, might hint at the computational security of the scheme, in case the participant is interested in breaking it. The Homomorphic Encryption Standard [1] may assist in choosing recommended parameters for implementation.

In practice, the proposed process provides the participants with a reduced polynomial in some finite field, but the actual operation does not consider that fact. The result can be maintained in the respected finite field by applying a blind modulo operation on each polynomial evaluation. This can be done by the previous method described in Algorithm 7. Moreover, to successively evaluate the polynomial without consuming all noise budget of the FHE scheme, one can utilize a bootstrapping method, thus allowing the computation to carry on endlessly.

### Example of Blind String Matching via DUFSM

For the sake of simplicity and readability the task of searching the word “nano” in a (possibly unbounded streaming) large text is considered. In fact, any state machine computation, where the current state is maintained only in (FHE CRT) secret shared form can be supported, thereby eliminating the need of the computation delegating client, to protect the current state security and privacy (avoiding single point of failure) and carrying the computation of the transition function. This problem can be presented as a distributed computation problem, where each participant text characters are sent one after the other, and expect them to yield a positive result if and only if the sequence “nano” was detected among the received characters. The negative or positive results collect from all participants and the correct result is decided by using the majority, thus eliminating any Byzantine errors. In this scenario, both the string to search and the text itself are shared in clear-text for all participants, along with the string-matching algorithm. The RSM solution reflects a “naive” (as repetition codes) approach for error correction, where there are codes with equivalent Hamming distance, such that in total they use a smaller number of bits [4]. In turn, a different scenario is considered, where all inputs are kept secret and the algorithm is unknown to the parties participating in the distributed computation.

One can build a simple automaton for that specific task, disregarding any preprocessing operations as done in the Boyer Moore algorithm [7]. In this simple automaton, there are only five states—an “empty” state denoted by ϵ, and four other states, each of them representing a valid substring of “nano”. For the sake of clarity, the transition table is detailed in Table 1.

TABLE 1
Transition Table

| | n | a | o | other |
|---|---|---|---|---|
| ϵ | n | ϵ | ϵ | ϵ |
| n | n | na | ϵ | ϵ |
| na | nan | ϵ | ϵ | ϵ |
| nan | n | na | nano | ϵ |
| nano | nano | nano | nano | nano |

For the sake of convenience, the state machine is also detailed in FIG. 2.

Following this data, all the possible letters (inputs) are encoded as integers and later used to simulate a transition from one state to another. The most straightforward method to use in this encoding is a map of each character to its real ASCII value. However, the English alphabet values are located in the ASCII table in a non-continuous manner. Namely, the values have undesired gaps between them. This is a disadvantage, mainly in case when an interpolating polynomial is created for the state machine. Also, using the ASCII table introduces limitation to a single text encoding, solely for the English language. It is possible to work around this limitation by creating a map of characters to values for every possible encoding. However, this solution might be unscalable for different texts, as texts are encoded differently, and creating as many tables as text encoding requires undesired preprocessing work.

A different hybrid method is to use these two techniques together. Namely, it is possible to define an encoding, where each character is mapped to an integer v from the respected text encoding table, only this time, it is subtracted by an offset value off, such that the minimum possible value vₘᵢₙ becomes vₘᵢₙ−off=1. This way, although the unwanted gaps are not eliminated, each character value is minimized, while allowing an application of this method for any text encoding.

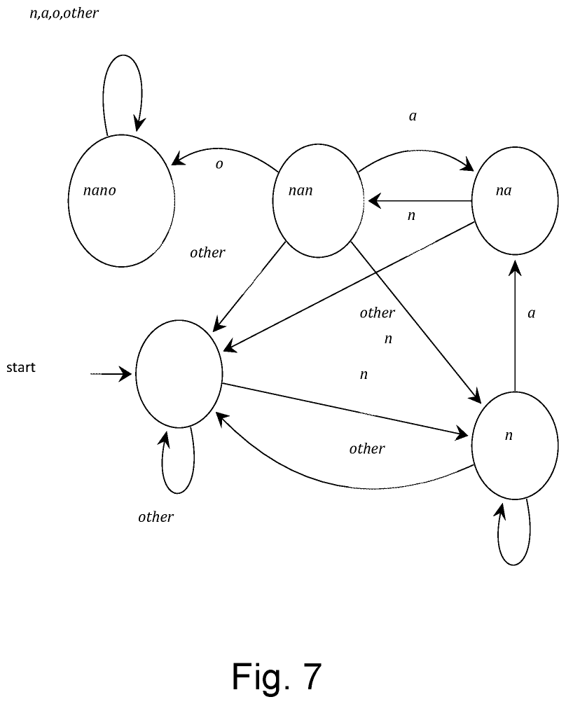

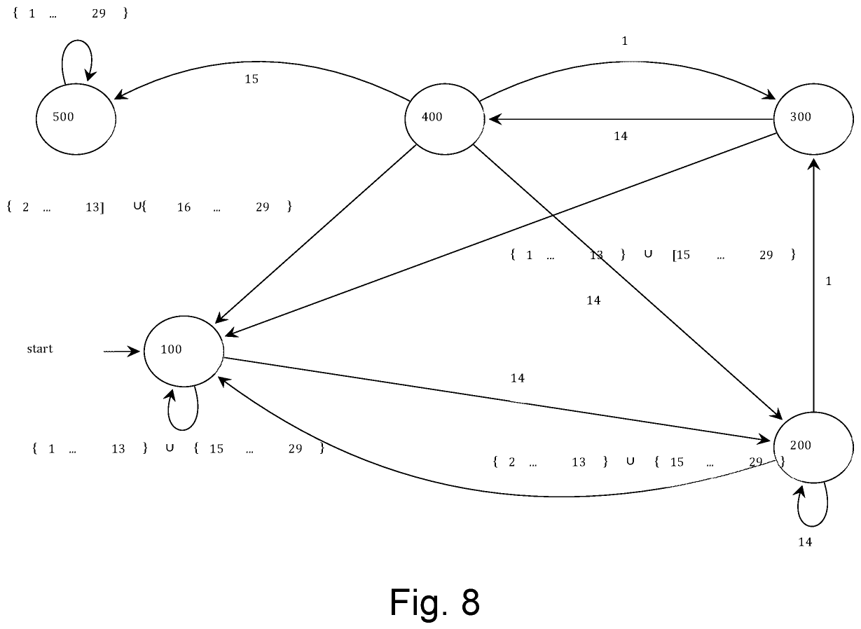

Once the encoding of the input is completed, the the states of this machine are encoded as integers. This is done using a set of integers, with a constant distance d between them, such that the highest value of an input Vₘₐₓ holds Vₘₐₓ<d. In that way, it is guaranteed that there are no overlaps between states while computing the transitions (recall the algorithm of state and transition encoding, where the encoding of a state is summed together with the encoding of an input). Finally, based on the simple state machine from before, it is possible to build an encoded FSM as, shown in FIG. 7.

The automaton using a decimal base is demonstrated, while in practice, binary base is more efficient. The five states above are encoded as integers with a factor of f=10² and a similarly a range of {1 . . . 5}, such that: 1·10²=100,2·10²=200,3·10²=300,4·10²=400,5·10²=500. Also, all inputs are encoded as integers in the range {1 . . . 29} to represent the English alphabet and the punctuation signs such as spaces, dots, and newlines.

Following Algorithm 9, a list of points is built, each representing a transition in the state machine from one state to another with some input. This list is sparse, namely, it does not include invalid or non-existent transitions. Therefore, when the polynomial interpolation is applied, invalid values will result in invalid or unexpected results (see Appendix B for the complete list of encoded points).

Next, following Alg. 8, an interpolating polynomial P(x) is built such that P(x)∈ [symbol] /K [symbol] [X]. Namely, besides that all the points detailed above fit into the polynomial, all the polynomial's coefficients are in [symbol] /K [symbol] for some relatively primes p₁, . . . , pₖ and a product K=Πᵢ^{k}pᵢ.

As a result of a large number of encoded points, this polynomial has a high degree. However, this is acceptable as it is only evaluated under some finite field and there is no risk of overflowing or exceeding memory resources. As soon as the interpolation step is completed, modulo reduction is immediately applied to each participant and the reduced polynomial is distributed to start the computation.

The above examples and description have of course been provided only for the purpose of illustrations, and are not intended to limit the invention in any way. As will be appreciated by the skilled person, the invention can be carried out in a great variety of ways, employing more than one technique from those described above, all without exceeding the scope of the invention.

### REFERENCES

[1] N. Agrawal, A. S. Shamsabadi, M. J. Kusner, and A. Gascón. Quotient: Two-party secure neural network training and prediction. In CCS '19, 2019.
[2] M. Ben-Or, S. Goldwasser, and A. Wigderson. Completeness theorems for non-cryptographic fault-tolerant distributed computation. In STOC '88, 1988.
[3] D. Berend, D. Bitan, and S. Dolev. Polynomials whose secret shares multiplication preserves degree for 2-cnf circuits over a dynamic set of secrets. IACR Cryptol. ePrint Arch., 2019:1192, 2019.
[4] D. Chaum, C. Crépeau, and I. Damgård. Multiparty unconditionally secure protocols. In STOC '88, 1988.
[5] D. Demmler, T. Schneider, and M. Zohner. Aby—a framework for efficient mixed-protocol secure two-party computation. In NDSS, 2015.
[6] P. Derbeko, S. Dolev, and E. Gudes. Deep neural networks as similitude models for sharing big data. In 2019 IEEE International Conference on Big Data (Big Data), Los Angeles, CA, USA, Dec. 9-12, 2019, pages 5728-5736. IEEE, 2019.
[7] P. Derbeko, S. Dolev, and E. Gudes. Mldstore—dnns as similitude models for sharing big data (brief announcement). In S. Dolev, D. Hendler, S. Lodha, and M. Yung, editors, Cyber Security Cryptography and Machine Learning-Third International Symposium, CSCML 2019, Beer-Sheva, Israel, Jun. 27-28, 2019, Proceedings, volume 11527 of Lecture Notes in Computer Science, pages 93-96. Springer, 2019.
[8] C. Gentry. Fully Homomorphic Encryption Using Ideal Lattices. In Proceedings of the 41st Annual ACM Symposium on Theory of Computing, pages 169-178, New York, NY, USA, 2009. ACM.
[9] R. Gilad-Bachrach, N. Dowlin, K. Laine, K. E. Lauter, M. Naehrig, and J. R. Wernsing. Cryptonets: Applying neural networks to encrypted data with high throughput and accuracy. In ICML, 2016.
[10] E. Hesamifard, H. Takabi, and M. Ghasemi. Cryptodl: Deep neural networks over encrypted data. CoRR, abs/1711.05189, 2017.
[11] N. Kumar, M. Rathee, N. Chandran, D. Gupta, A. Rastogi, and R. Sharma. Cryptflow: Secure tensorflow inference, 2019.
[12] P. Mohassel and Y. Zhang. Secureml: A system for scalable privacy-preserving machine learning. In 2017 IEEE Symposium on Security and Privacy (SP), pages 19-38, May 2017.
[13] B. D. Rouhani, M. S. Riazi, and F. Koushanfar. Deepsecure: scalable provably-secure deep learning. In DAC, 2018.
[14] A. Shamir. How to share a secret. Commun. ACM, 22(11):612613″€λ, Nov. 1979.
[15] S. Wagh, D. Gupta, and N. Chandran. Securenn: Efficient and private neural network training. IACR Cryptology ePrint Archive, 2018:442, 2018.
[16] P. Xie, M. Bilenko, T. Finley, R. Gilad-Bachrach, K. E. Lauter, and M. Naehrig. Crypto-nets: Neural networks over encrypted data. ArXiv, abs/1412.6181, 2014.
[17] Martin Albrecht et al. 2018. url: https://eprint.iacr.org/2019/939. pdf.
[18] Charles Asmuth and John Bloom. “A modular approach to key safeguarding”. In: IEEE Trans. Information Theory 29.2 (1983), pp. 208-210. doi: 10.1109/tit.1983.1056651. url: https://doi.org/10.1109/TIT. 1983.1056651.
[19] Hillel Avni, Shlomi Dolev, Niv Gilboa, and Ximing Li. “SSSDB: Database with Private Information Search”. In: February 2016, pp. 49-61. isbn: 978-3-319-29918-1. doi: 10.1007/978-3-319-29919-8_4.
[20] Bharath Balasubramanian and Vijay K. Garg. “Fault tolerance in distributed systems using fused state machines”. In: Distributed Computing 27.4 (August 2014), pp. 287-311. issn: 1432-0452. doi: 10.1007/s00446-014-0209-4. url: https://doi.org/10.1007/s00446-014-0209-4.
[21] Dor Bitan and Shlomi Dolev. “Optimal-Round Preprocessing-MPC via Polynomial Representation and Distributed Random Matrix (extended abstract)”. In: IACR Cryptology ePrint Archive 2019 (2019), p. 1024. url: https://eprint.iacr.org/2019/1024.
[22] G. R. Blakley. “Safeguarding cryptographic keys”. In: Proceedings of the 1979 AFIPS National Computer Conference. Monval, NJ, USA: AFIPS Press, 1979, pp. 313-317.
[23] Robert S. Boyer and J. Strother Moore. “A Fast String Searching Algorithm”. In: Commun. ACM 20.10 (October 1977), pp. 762-772. issn: 00010782. doi: 10.1145/359842.359859. url: https://doi.org/10.1145/359842.359859.
[24] Elette Boyle, Nishanth Chandran, Niv Gilboa, Divya Gupta, Yuval Ishai, Nishant Kumar, and Mayank Rathee. Function Secret Sharing for MixedMode and Fixed-Point Secure Computation. Cryptology ePrint Archive, Report 2020/1392. https://eprint.iacr.org/2020/1392. 2020.
[25] Elette Boyle, Niv Gilboa, and Yuval Ishai. Secure Computation with Preprocessing via Function Secret Sharing. Cryptology ePrint Archive, Report 2019/1095. https://eprint.iacr.org/2019/1095. 2019.
[26] Hagar Dolev and Shlomi Dolev. Toward Provable One Way Functions. Cryptology ePrint Archive, Report 2020/1358. https://eprint.iacr.org/2020/1358. 2020.
[27] Shlomi Dolev, Karim Eldefrawy, Juan Garay, Muni Venkateswarlu Kumaramangalam, Rafail Ostrovsky, and Moti Yung. “Brief Announcement: Secure Self-Stabilizing Computation”. In: Proceedings of the ACM Symposium on Principles of Distributed Computing. Podc '17. Washington, DC, USA: Association for Computing Machinery, 2017, pp. 415-417. isbn: 9781450349925. doi: 10.1145/3087801.3087864. url: https://doi.org/10.1145/3087801.3087864.
[28] Shlomi Dolev, Juan Garay, Niv Gilboa, and Vladimir Kolesnikov. “Secret Sharing Krohn-Rhodes: Private and Perennial Distributed Computation.” In: January 2011, pp. 32-44.
[29] Shlomi Dolev, Juan A. Garay, Niv Gilboa, Vladimir Kolesnikov, and Muni Venkateswarlu Kumaramangalam. “Perennial secure multi-party computation of universal Turing machine”. In: Theor. Comput. Sci. 769 (2019), pp. 43-62. doi: 10.1016/j.tcs.2018.10.012. url: https://doi.org/10.1016/j.tcs.2018.10.012.
[30] Shlomi Dolev, Juan A. Garay, Niv Gilboa, Vladimir Kolesnikov, and Yelena Yuditsky. “Towards efficient private distributed computation on unbounded input streams”. In: J. Mathematical Cryptology 9.2 (2015), pp. 79-94. doi: 10.1515/jmc-2013-0039. url: https://doi.org/10.1515/jmc-2013-0039.
[31] Shlomi Dolev, Niv Gilboa, and Ximing Li. “Accumulating automata and cascaded equations automata for communicationless information theoretically secure multi-party computation”. In: Theor. Comput. Sci. 795 (2019), pp. 81-99. doi: 10.1016/j.tcs.2019.06.005. url: https://doi.org/10.1016/j.tcs.2019.06.005.
[32] Shlomi Dolev, Limor Lahiani, and Moti Yung. “Secret swarm unit: Reactive k-secret sharing”. In: Ad Hoc Networks 10.7 (2012), pp. 1291-1305. issn: 1570-8705. doi: https://doi.org/10.1016/j.adhoc.2012.03.011. url: http://www.sciencedirect.com/science/article/pii/S1570870512000613.
[33] Shlomi Dolev and Yin Li. “Secret Shared Random Access Machine”. In: Algorithmic Aspects of Cloud Computing. Ed. by loannis Karydis, Spyros Sioutas, Peter Triantafillou, and Dimitrios Tsoumakos. Cham: Springer International Publishing, 2016, pp. 19-34.
[34] Craig Gentry. “Fully Homomorphic Encryption Using Ideal Lattices”. In: STOC '09. Bethesda, MD, USA: Association for Computing Machinery, 2009, pp. 169-178. isbn: 9781605585062. doi: 10.1145/1536414.1536440. url: https://doi.org/10.1145/1536414.1536440.
[35] Oded Goldreich, Dana Ron, and Madhu Sudan. “Chinese remaindering with errors”. In: IEEE Trans. Information Theory 46.4 (2000), pp. 1330-1338. doi: 10.1109/18.850672. url: https://doi.org/10.1109/18.850672.
[36] R. Jaiswal. “Chinese Remainder Codes : Using Lattices to Decode Error Correcting Codes Based on Chinese Remaindering Theorem”. In: 2007.
[37] Artur Jakubski. “Selected application of the Chinese Remainder Theorem in multiparty computation”. In: Journal of Applied Mathematics and Computational Mechanics 2016 (January 2016), pp. 39-47. doi: 10.17512/jamcm.2016.1.04.
[38] Leslie Lamport. “Fast Paxos”. In: Distrib. Comput. 19.2 (October 2006), pp. 79-103. issn: 0178-2770. doi: 10.1007/500446-006-0005-x. url: https://doi.org/10.1007/s00446-006-0005-x.
[39] Leslie Lamport. “Time, Clocks, and the Ordering of Events in a Distributed System”. In: Commun. ACM 21.7 (July 1978), pp. 558-565. issn: 0001-0782. doi: 10.1145/359545.359563. url: https://doi.org/10. 1145/359545.359563.
[40] Yongnan Li, Limin Xiao, Aihua Liang, Yao Zheng, and Li Ruan. “Fast Parallel Garner Algorithm for Chinese Remainder Theorem”. In: September 2012, pp. 164-171. isbn: 978-3-642-35605-6. doi: 10.1007/978-3-642-35606-319.
[41] R. L. Rivest, L. Adleman, and M. L. Dertouzos. “On data banks and privacy homomorphisms”. In: Foundations on Secure Computation, Academia Press. 1978, pp. 169-179.
[42] Tomas Sauer. “Polynomial interpolation of minimal degree”. In: Numerische Mathematik 78 (November 1997), pp. 59-85. doi: 10.1007/5002110050304.
[43] Adi Shamir. “How to Share a Secret”. In: Commun. ACM 22.11 (1979), pp. 612-613. doi: 10.1145/359168.359176. url: http://doi.acm.org/10.1145/359168.359176.
[44] Huiyong Wang, Yong Feng, Yong Ding, and Shijie Tang. “A Homomorphic Arithmetic Model via HElib”. In: Journal of Computational and Theoretical Nanoscience 14 (November 2017), pp. 5166-5173. doi: 10.1166/jctn. 2017.6690.

### Appendix A

### Finite Rings and Finite (Galois) Fields

The type of field that has a finite number of elements is first introduced. This number is a power pⁿ of some prime number p. In fact, for any prime number p and any natural number n there exists a unique field of pⁿ elements that is denoted by GF (pⁿ) or by [symbol] ₚ_{ⁿ}. Conveniently, all standard operations such as multiplication, addition, subtraction, and division (excluding division by zero) are defined and satisfy the rules of arithmetic, just as the corresponding operations on rational and real numbers do. This type of field helps quite often to think and calculate, in terms of integers, modulo another number. Fix an integer n . The integers modulo n denoted [symbol] /nZ, is the set of numbers 0,1,2, . . . ,n−1, with addition and multiplication defined by taking the remainder upon division by n. Reducible integers n such that n=p₁, . . . , pₖ for some k>0 primes are specifically of interest. A key observation here is that when all the pᵢ are co-prime (referred to as relatively prime sometimes) then any number modulo n that is divided by these p, gives a unique sequence of residues. Formally, this observation is a restatement of the CRT which is explained below.

CRT Arithmetic. Let p₁<p₂<. . . <pₖ where pᵢ are relatively prime and a set of congruence equations a≡aᵢ(modpᵢ) for 1≤i≤k for k>0 and where aᵢ are remainders. The original form of the CRT states that this given set of congruence equations always has one and exactly one solution modulo Π₁^{k} pᵢ.

Similar to the previous notation, this theorem is often restated as:

[symbol]

/a [symbol] ≅ [symbol] /p₁ [symbol] ×. . . × [symbol] /pₖ [symbol] (11)

This means that by doing a sequence of arithmetic operations in [symbol] /a [symbol] one may do the same computation independently in each [symbol] /pᵢ [symbol] and then get the result by applying the isomorphism from the right to the left. This operation is refer to as the recovery process later on.

The integer m=14 can be represented as a set of these congruence equations:

14≡2(mod3),14≡4(mod5),

14≡0(mod7),14≡3(mod11) (12)

More significantly, m=14 is the exact and only solution modulo 3·5·7·11=1155.

This feature of CRT allows to represent big numbers using a small array of integers. Namely, when performing arithmetic operations on big numbers this feature assists in preserving memory resources.

### Byzantine Fault Tolerance

The assumption that every participant in a distributed system correctly follows the algorithm may not hold in reality. Either because of faults or malicious takeovers. Therefore, distributed systems are often designed to tolerate a part (typically less than ⅓) of the participants that are acting as if controlled by a malicious adversary. These participants are called Byzantine participants.

### Secure Multiparty Computation

To further demonstrate the effectiveness of a joint operation as detailed in [21], consider a series of arithmetic calculations, done over t-bits numbers in the form of b₁, . . . , bₜ. The additions in this series might add up to 1 bit between each calculation, but the multiplications might double the number of bits. Thus, if the whole operation is completed individually by a single party, it might require up to t² bits in the worst case. However, if the CRT representation is use and the moduli are split into several parties, each calculation is perfored individually while achieving a bounded number of bits per party (bound as large as implied by the largest modulus). Namely, to support calculations of up to t² bits, i.e numbers up to 2^{t}^{²}, it is sufficient to setup k parties and k primes (moduli) p₁, . . . , pₖ that:

2^{t}^{²}<Πᵢ₌₁^{k}pᵢ (13)

This observation leads to the conclusion that it is possible to decide whether to use a few large primes or many small primes to carry out the same series of calculations. This decision might change according to the availability of more parties and the number of memory resources to be consumed.

As previously explained, the calculation result of each participant can be collected and recovered into a unique result in [symbol] _{K} where K=Πᵢ₌₁^{k}pᵢ.

TABLE 2
Encoded Points
Appendix B
Polynomial Points.

| | | | | |
|---|---|---|---|---|
| (101, 100) | (201, 300) | (301, 100) | (401, 300) | (501, 500) |
| (102, 100) | (202, 100) | (302, 100) | (402, 100) | (502, 500) |
| (103, 100) | (203, 100) | (303, 100) | (403, 100) | (503, 500) |
| (104, 100) | (204, 100) | (304, 100) | (404, 100) | (504, 500) |
| (105, 100) | (205, 100) | (305, 100) | (405, 100) | (505, 500) |
| (106, 100) | (206, 100) | (306, 100) | (406, 100) | (506, 500) |
| (107, 100) | (207, 100) | (307, 100) | (407, 100) | (507, 500) |
| (108, 100) | (208, 100) | (308, 100) | (408, 100) | (508, 500) |
| (109, 100) | (209, 100) | (309, 100) | (409, 100) | (509, 500) |
| (110, 100) | (210, 100) | (310, 100) | (410, 100) | (510, 500) |
| (111, 100) | (211, 100) | (311, 100) | (411, 100) | (511, 500) |
| (112, 100) | (212, 100) | (312, 100) | (412, 100) | (512, 500) |
| (113, 100) | (213, 100) | (313, 100) | (413, 100) | (513, 500) |
| (114, 200) | (214, 200) | (314, 400) | (414, 200) | (514, 500) |
| (115, 100) | (215, 100) | (315, 100) | (415, 500) | (515, 500) |
| (116, 100) | (216, 100) | (316, 100) | (416, 100) | (516, 500) |
| (117, 100) | (217, 100) | (317, 100) | (417, 100) | (517, 500) |
| (118, 100) | (218, 100) | (318, 100) | (418, 100) | (518, 500) |
| (119, 100) | (219, 100) | (319, 100) | (419, 100) | (519, 500) |
| (120, 100) | (220, 100) | (320, 100) | (420, 100) | (520, 500) |
| (121, 100) | (221, 100) | (321, 100) | (421, 100) | (521, 500) |
| (122, 100) | (222, 100) | (322, 100) | (422, 100) | (522, 500) |
| (123, 100) | (223, 100) | (323, 100) | (423, 100) | (523, 500) |
| (124, 100) | (224, 100) | (324, 100) | (424, 100) | (524, 500) |
| (125, 100) | (225, 100) | (325, 100) | (425, 100) | (525, 500) |
| (126, 100) | (226, 100) | (326, 100) | (426, 100) | (526, 500) |
| (127, 100) | (227, 100) | (327, 100) | (427, 100) | (527, 500) |
| (128, 100) | (228, 100) | (328, 100) | (428, 100) | (528, 500) |
| (129, 100) | (229, 100) | (329, 100) | (429, 100) | (529, 500) |

1. A method for performing effective secure multi-party computation by participating parties being one or more computerized devices for executing said tasks, with no communication between the parties, using at least one trained Deep Neural Network (DNN), comprising:
a) approximating said at least one trained DNN by polynomial functions representing a single or multiple layers of said DNN by:
a.1) representing each neuron unit of said DNN by a polynomial being a weighted sum of vector multiplication of weights with an n-dimensional input;
a.2) representing the output of each neuron unit by applying an activation function to said weighted sum;
b) generating additive secret shares for every polynomial coefficient;
c) distributing said secret shares among said participating parties;
d) sending the input x to said participating parties, for execution;
e) after execution, receiving the output of polynomial activation function of each participating party; and
f) outputting the final result as the sum of the received output.

2. The method according to claim 1, wherein the trained DNN is approximated by a single polynomial or by a single nested polynomial that is being nested within the approximation of the next layer, such that a single polynomial approximates several layers of the DNN, or the entire DNN.

3-4. (canceled)

5. The method according to claim 1, further comprising preforming perfect information theoretically secure, secret-sharing MPC calculation of the polynomial representing the DNN.

6. The method according to claim 1, wherein the activation functions are selected form the group of:
ReLu (ReLu(x)=max(0, x)),
Leaky ReLu (similar to ReLu but LReLu(x)=0.01x if x≤0):
$$\\ Sigmoid ( σ ( x ) = \frac{1}{1 + {e}^{- x}} ) ;$$
$$\\ TANh ( tanh ( x ) = \frac{{e}^{{}^{} 2 x} - 1}{{e}^{{}^{} 2 x} + 1} ) ; and$$
$$\\ SoftMax ( σ ( {x}_{i} ) = \frac{{e}^{{}^{} {x}_{i}}}{{\sum }_{i = 1}^{k} {e}^{{}^{} {x}_{i}}} ) .$$

7. The method according to claim 1, wherein the polynomial represents multiplications and additions performed by a convolution layer of the DNN.

8. (canceled)

9. The method according to claim 1, wherein approximation of multiple layers of the DNN is performed by combining multiple layers into a single polynomial activation function, according to the connectivity of the layers.

10. The method according to claim 1, wherein non-dense layers are approximated using corresponding inputs from the previous layer.

11. The method according to claim 1, further comprising decreasing the degree of the polynomial by nesting.

12. The method according to claim 1, wherein the polynomial degree at layer l is limited by:
a) keeping the polynomials from layer l−1 as a sum of lower-degree polynomials;
b) calculating the polynomial Pᵢⱼ only once, during the calculating of each multi-layer polynomial.

13. The method according to claim 1, further comprising concealing the network architecture by:
a) adding pseudo-nodes to the DNN;
b) connecting said pseudo-node similarly to units of the dense layer, with input from all units of the previous layer and output connected to all units of the next layer;
c) nullifying the influence of the pseudo-units on the network inference by canceling the results of activating said pseudo units or nullifying an output edge weights.

14. The method according to claim 1, wherein the input is revealed to all participating parties and the secrets are the weights of the trained DNN.

15. (canceled)

16. The method according to claim 1, wherein the polynomial is blindly computed, where some of its coefficients being secret shares of zero, thereby allowing blind execution of the DNN.

17. (canceled)

18. A method for performing Statistical Information-Theoretical Secure (SITS) Distributed Communication-Less Secure Multiparty Computation (DCLSMPC) of a Distributed Unknown Finite State Machine (DUFSM), comprising:
a) passing secret shares of the input(s) and output(s) to/from the computing parties, with no communication between said computing parties throughout the computation;
b) providing a polynomial representation or a Look-Up Table (LUT) representation of the transition table of said DUFSM, for arithmetic circuits evaluation, joined with a CRT secret sharing scheme and FHE, to computationally mitigate information leakage from individual CRT shares;
c) implementing said DUFSM by secret sharing of said the transition table or the coefficients of said polynomial over a finite ring, to imply communication-less SMPC of said DUFSM, said polynomial encoding the information of all the transitions from a state x and input y to the next state z;
d) describing said polynomial by an arithmetic circuit that can be evaluated distributively by the SMPC participants, while allowing each participant to evaluate said arithmetic circuit using CRT-SITS secret sharing scheme where the shares are encrypted using FHE.

19. The method according to claim 18, wherein the computed transition function is kept private by using secret shares for all coefficients of the polynomial, while revealing only a bound on the maximal degree k of the polynomial.

20. The method according to claim 18, wherein independent additions and multiplications of the respective components of two or more numbers over a finite ring is enabled using CRT representation, where each participant performs calculations over a finite ring defined by its corresponding prime number.

21. The method according to claim 18, wherein the transition function of the state machine is represented by a bi-variate polynomial from the current state (x) and the input (y) to the next state (z).

22. The method according to claim 18, wherein the transition function of the state machine is represented by a univariate polynomial defined by using the most significant digits of (x+y) to encode the state (x) and the least significant digits, to encode the input (y).

23-24. (canceled)

25. The method according to claim 18, wherein a distributed calculation is carried out using a dealer-worker scheme, where a single party being a dealer is responsible for the assignment of tasks and collection of the results, while other parties being workers are responsible to the calculation itself, wherein:
the dealer is allowed to generate the appropriate primes and distributes them to the workers;
throughout the computation, the dealer manages a queue that is shared with the workers in such a manner that every time an input arrives, said input is pushed to the queue and popped in turn by the workers;
the dealer is allowed to recover the result.

26-28. (canceled)

29. The method according to claim 25, further comprising:
a) allowing the dealer to initialize an FHE for encrypting both the initial value and the incoming input;
b) decrypting the encrypted results;
c) reassembling the results by the CRT into a single solution.

30. A method for managing a trained data model of a neural network, comprising allowing a blockchain registered data owner to sell the rights on the data model services and/or at least a part of the ownership to other parties by representing the owned data as an executable cryptocoin.

31. (canceled)

32. A system for performing effective secure multi-party computation by participating parties being one or more computerized devices for executing said multi-party computation, with no communication between the parties, using at least one trained Deep Neural Network (DNN), comprising one or more computerized devices that contain one or more processors being adapted to:
a) approximate said at least one trained DNN by polynomial functions representing a single or multiple layers of said DNN by:
a.1) representing each neuron unit of said DNN by a polynomial being a weighted sum of vector multiplication of weights with an n-dimensional input;
a.2) representing the output of each neuron unit by applying an activation function to said weighted sum;
b) generate additive secret shares for every polynomial coefficient;
c) distribute said secret shares among said participating parties;
d) send the input x to said participating parties, for execution;
e) after execution, receive the output of polynomial activation function of each participating party; and
f) output the final result as the sum of the received output.
